(19) United States
(12) Patent Application Publication
(10) Pub. No.: US 2024/0249576 A1
(43) Pub. Date: Jul. 25, 2024

(54) INTELLIGENT SAFETY ENTRANCE/EXIT MANAGEMENT SYSTEM, METHOD AND DEVICE

(71) Applicant: LIHONG SAFETY EQUIPMENT ENGINEERING (SHANGHAI) CO., LTD., Shanghai (CN)

(72) Inventors: Hongying HOU, Shanghai (CN); Lee Anson Lap YIN, Shanghai (CN)

(21) Appl. No.: 18/218,771

(22) Filed: Jul. 6, 2023

(30) Foreign Application Priority Data
Jan. 20, 2023 (CN) 2023100795328

(51) Int. Cl. G07C 9/00; G06V 40/16; G06V 40/20; G07C 9/37

(52) U.S. Cl. CPC G07C 9/00563; G06V 40/172; G06V 40/20; G07C 9/00944; G07C 9/37; G07C 2209/08

(57) ABSTRACT

In an intelligent safety entrance/exit management system, method and device, by identifying the right status of the person who triggers the unlocking and the movement status of the lock cylinder moving out from the keyhole of the lock body to control the period of authorization for triggering the opening of the door, to realize that after the person who has trigger the unlocking pulls out the lock cylinder of the lock on the area door from the keyhole of the lock body, no one else can lock the door of the area. Also by tracking the person appearing in the video and identifying the direction of movement; when the person in the identification video enters the protective area, it identifies whether it is the person who triggers the unlocking; if not, it will issue a trailing alarm.

The present disclosure relates to the field of area protection technology, and specifically to an intelligent safety entrance and exit management system and method.

### BACKGROUND OF THE INVENTION

Lock Out Tag Out (LOTO) has always been an important safety standard in the safe use of equipment, most of the global production companies will require maintenance personnel to comply with this lock out tag out operation to avoid accidental opening of equipment during maintenance to ensure the safety of personnel in the process of maintenance of equipment, especially in the field of industrial production, according to the risk level of Different degrees of regional protection for different hazardous areas, the entrance to hazardous areas are usually equipped with access control. And with the continuous development of industrial intelligence, equipment are gradually toward automation, intelligent development, no longer completely rely on people to operate, but intelligent LOTO, operation maintenance personnel because they do not carry a physical key, there will be maintenance personnel into the maintenance has not yet left, external personnel but the locking of the door, endangering the safety of the lives of maintenance personnel.

### SUMMARY OF THE INVENTION

To solve the above problems, the purpose of the present invention is to provide an intelligent security entrance/exit management system and method to achieve the effect that the maintenance personnel have not yet left and the external personnel cannot lock the door to the protection area, solving the problem of life safety of the maintenance personnel caused by being locked in the protection area.

An aspect of the present invention provides an intelligent security entrance/exit management system, applied in the field of area protection, having a tapered ned with a removable lock cylinder and/or guide column and a lock body with a keyhole, the keyhole having a diameter greater than or equal to the diameter of the lock cylinder, the intelligent security entrance/exit management system comprising: an identification module, a control module.

The identification module for identifying the rights status of the person triggering the unlocking and the movement status of the lock cylinder moving out of the keyhole of the lock body and/or the rights status of the person triggering the locking and the movement status of the lock cylinder moving in towards the keyhole of the lock body.

the control module for controlling the process of triggering the opening of the door during the authorization and carrying out the operation according to the recognition result of the recognition module, causing the lock body to change from the locked status to the unlocked status then to the locked status and to maintain the locked state, or controlling the process of triggering a locking door authorization during which said lock body is caused to change from a locked status to an unlocked status to a locked status again and to remain locked.

According to an embodiment of the present invention, further comprising a control panel, an authorization module, a Save Module; the identification module includes a Access identification module and a lock cylinder identification module; the control module includes a locking control module and an unlocking control module, the control panel for receiving signals and sending the signals to the authority identification module, the Save Module for pre-storing information of staff and/or storing information of the triggered unlocking personnel having the right to open the door and/or storing information of the triggered locking personnel having the right to lock the door; the authority identification module for identifying the door opening identity and/or locking door identity of the trigger unlocking person based on the signals received from the control panel and the information stored in the Save Module, and sending an opening authorization signal and/or locking door authorization signal to the authorization module when the result of the opening identity identification and/or the locking door identity identification is passed, the lock cylinder identification module for identifying the movement status of the lock cylinder in the keyhole, sending a locking control signal to the locking control module when the identification result is the movement status of the lock cylinder moving out from the keyhole; sending a locking control signal to the locking control module when the identification result is the movement status of the lock cylinder moving in towards the keyhole, the authorization module for authorizing the trigger unlocking person who passes the opening identity identification to open the door, storing information of the trigger unlocking person who has the right to open the door this time and/or for authorizing the locking person who passes the locking identity identification to lock the door, storing information of the trigger unlocking person who has the right to lock the door this time, the locking control module for controlling the lock body from an unlocked status to a locked status and maintaining the locked status on the basis of the locking control signal received from the locking core identification module, the unlocking control module for controlling the lock body from the locked status to the unlocked status according to the unlocking control signal received from the authorization module, and then sending a lock cylinder identification start signal to the lock cylinder identification module for starting the lock cylinder identification module for identification.

According to an embodiment of the present invention, further comprising a trigger unlocking person matching module, a trigger locking person matching module; the trigger unlocking personnel for open door identification includes matching the trigger unlocking personnel's information with the pre-stored information of staff with authority through the trigger unlocking personnel matching module, when the matching result for the trigger unlocking personnel is a successful match, then the open door identification passes; the trigger-on personnel for lock door identification includes matching the information of the trigger-on personnel with the information of the trigger-unlocked personnel having the right to open the door this time through the trigger-on personnel matching module, and when the matching result for the trigger-on personnel is a successful match, then the lock door identification passes.

According to an embodiment of the present invention, further comprising a trigger unlocking person matching module, a trigger locking person matching module, a counting module and a quantity judgment module, the trigger unlocking person being greater than one person and the trigger locking person being greater than one person. The carrying out door opening identification includes matching the information of the trigger unlocking personnel of the greater than 1 person with the information of the pre-stored staff with authority respectively by the trigger unlocking personnel matching module, when the matching result is all successful, then the locking door identification passes; the counting module for counting the triggered locking personnel, specifically comprising counting the triggered locking personnel, matching the information of the triggered locking personnel of greater than 1 person with the stored information of the triggered unlocking personnel having the right to open the door at this time, respectively, by the triggered locking personnel matching module, and when the matching result for any of the triggered locking personnel is a successful match, then the counting module counts; the quantity judgment module is used to judge the counting data of the counting module, and when the counting module counting data is the same as the quantity data of the triggered unlocked person for this time, then the locking door identification passes.

According to an embodiment of the present invention, further comprising a video acquisition module, a motion direction identification module and a judgment module for this trigger unlocking person, the video acquisition module for real-time acquisition including the protective area in front of the door, the doorway of the protective area, and the video within the protective area, the motion direction identification module is used to track the person appearing in the video and carry out the identification of motion direction; when the identification result is that the motion direction is from the front of the protective area door to the entrance of the protective area to the inside of the protective area, the identification of whether the person is this trigger to unlock is carried out; the trigger unlocking person judgment module is used to identify whether it is this trigger unlocking person; when the identification result is not this trigger unlocking person, the trailing alarm is issued.

One aspect of the present invention provides an intelligent security entrance/exit management method, applied in the field of area protection, having a tapered ned with a removable lock cylinder and/or a guide post and a lock body having a keyhole, the keyhole having a diameter greater than or equal to the diameter of the lock cylinder, the intelligent security entrance/exit management method comprising the steps of: triggering an open door authorization period and performing the operation; said open door authorization period being the process by which the lock body changes from a locked status to an unlocked status to a locked status and back again, and remains locked, depending on the status of the right of the person triggering the unlocking and the movement of the lock cylinder moving out of the keyhole of said lock body, triggering the lock door authorization period; the locking door authorization period being the process of the lock body shifting from the locked status to the unlocked status to the locked status again and maintaining the locked status in accordance with triggering the right status of the locking person and the movement status of the lock cylinder moving in towards the keyhole of the lock body.

According to an embodiment of the present invention, the triggers to open the door during authorization and conducts the operation specifically comprising the steps of: receiving a signal and sending the signal to the authority identification module; identifying the triggering unlocking person to open the door based on the received signal and stored information, and sending an open door authorization signal when the open door identification result is passed, to carry out door opening authorization to the trigger unlocking person according to the door opening authorization signal received, store the information of the trigger unlocking person who has the right to open the door this time, and send an unlocking control signal, controlling the lock body from a locked status to an unlocked state, according to the unlocking control signal received, sending a lock cylinder identification start signal for activating the lock cylinder identification module for identification, identifying the movement status of the lock cylinder in the keyhole, and sending a locking control signal when the result of the identification is the movement status of the lock cylinder moving out from the keyhole, controlling the lock body to change from an unlocked status to a locked status and to maintain the locked status according to the locked control signal received, the triggering lock during door authorization specifically comprising the steps of: receiving a signal and sending the signal to the authority identification module, performing a lock door identification of the trigger locking person based on the received signal and stored information, and sending a lock door authorization signal when the lock door identification result is passed, performing locking authorization on the trigger-on person according to the locking authorization signal received, storing information about the trigger-on person with locking rights this time, and sending an unlocking control signal, controlling the lock body to change from a locked status to an unlocked state, according to the unlocking control signal received, sending a lock cylinder identification start signal for activating the lock cylinder identification module for identification; identifying the movement status of the lock cylinder in the keyhole, sending a locking control signal when the result of the identification is the movement status of the lock cylinder moving in towards the keyhole, controlling the lock body from an unlocked status to a locked status and maintaining the locked status according to the locked control signal received.

According to an embodiment of the present invention, the triggering unlocking personnel for door opening identification comprises matching information of the triggering unlocking personnel with information of staff with pre-stored permissions, and when the matching result for the triggering unlocking personnel is a successful match, the door opening identification passes; the triggering locking personnel for lock door identification comprises matching the information of the triggering locking personnel with the information of the triggering unlocking personnel having the right to open the door this time the triggering unlocking personnel, and when the matching result for the triggering locking personnel is a successful match, the lock door identification passes.

According to an embodiment of the present invention, the trigger unlocking personnel is greater than 1 person and the trigger locking personnel is greater than 1 person, the carrying out door opening identification includes matching the information of the trigger unlocking personnel of the greater than 1 person with the information of the pre-stored staff with authority respectively, when the matching result is all successful, then the lock door identification passes; the carrying out locking door identification comprises the steps of: counting the triggered locking personnel, matching the information of the triggered locking personnel greater than one with the stored information of the triggered unlocking personnel having the right to open the door this time respectively, and when the matching result for any of the triggered locking personnel is a successful match, then the counting module counts, judgment on the counting data of the counting module, when the counting data of the counting module is the same as the data of the number of the trigger unlocked persons this time, then the lock door identification passes.

According to an embodiment of the present invention, the further comprising real-time tailing detection after triggering door opening authorization period; specifically comprising the steps of, capturing in real time video including in front of the guarded area door, at the guarded area entrance, and within the guarded area, tracking the person appearing in the video and performing identification of the direction of movement; when the identification result is that the direction of movement is from in front of the protective area door to the protective area doorway to within the protective area, performing identification of whether or not the person is this trigger to unlock, identification of whether it is this trigger to unlock the person; when the identification result is that it is not this trigger to unlock the person, then a trailing alarm is issued.

According to an embodiment of the present invention, the lock body includes a face recognition screen and/or an unlock/lock indicator and/or a status indicator and/or a reset button and/or a safety emergency stop button and/or a forced unlock keyhole and/or a cooling fan and/or a connector and/or a lock body mounting hole; the tapered ned includes a guide post and/or a slidable tapered ned and/or a door handle mounting waist hole.

According to an embodiment of the present invention, the locking control module sends a locking control signal while controlling the locking indicator light to indicate to the user that the current status of the security entrance/exit management system is locked; the unlocking control module sends an unlocking control signal while controlling the unlocking indicator light to indicate to the user that the current status of the security entrance/exit management system is unlocked; the triggering door opening authorization During the locking authorization period, the status indicator lights up for prompting the user the current status of the security import and export management system for the opening authorization period; the locking authorization period, when the lock cylinder identification module identifies the result of the movement status of the lock cylinder moving into the keyhole, press the reset button, the equipment in the hazardous area before starting to improve security; the safety emergency stop button, in case of emergency can control the source of danger emergency stop button to block the occurrence of danger or to avoid the danger that has occurred to reach a more serious situation.

The advantages of the present invention are:

The present invention discloses an intelligent safety import and export management system and method. By identifying the right status of the trigger unlocking personnel and the movement status of the lock cylinder moving out from the keyhole of the lock body to control the trigger opening authorization period, in order to achieve the right trigger unlocking personnel to pull out the lock cylinder of the lock on the area door from the keyhole of the lock body, other people can not lock the door of the area, so as to achieve the effect that the maintenance personnel have not yet left, external personnel can not lock the door of the protection area. Solve the maintenance personnel's life safety problems caused by being locked in the protective area.

However, this will not be able to lock the area, there will be other people accidentally enter the problem of life safety. Thus, the present application controls the period of triggering the lock door authorization by triggering the right status of the locking personnel and the movement status of the lock cylinder moving into the keyhole of the lock body, so that the person with the authority to open the door has the authority to lock the dangerous area, in order to solve the problem of being unable to lock the area and causing personnel to enter by mistake, thus causing life safety.

By adding the trigger unlocking personnel matching module, trigger locking personnel matching module, counting module and quantity judgment module, in the case where the trigger unlocking personnel is greater than 1 person and the trigger locking personnel is greater than 1 person, the locking door identification is performed by counting the trigger locking personnel and judging the counting data, and when the counting data is the same as the data of the number of triggered unlocking personnel, the locking door identification is passed. Identification through, so as to achieve the need for multiple operations, only when the identification of all operators to all leave the operating area, the area can be locked.

Due to the above invention there is an open door authorization period, and thus there is also the problem that non-operators trailing into the dangerous area may damage the equipment and also cause life safety. In view of this, the invention also through the addition of video acquisition module, motion direction identification module and this trigger to unlock the personnel judgment module, real-time acquisition including the protective area in front of the door, the doorway of the protective area, and the protective area within the video; tracking the people appearing in the video and the identification of the direction of motion; when the identification results in the direction of motion from the protective area in front of the door to the doorway of the protective area to the protective area When the result is that the direction of movement is from in front of the door of the protection area to the door of the protection area to the protection area, the identification of whether the person is the person who triggers the unlocking is carried out; when the result is that the person is not the person who triggers the unlocking, the trailing alarm is issued. Thus, it realizes the tracking of the person who enters inside the protective area from outside the protective area, combined with the judgment of whether the person has the authority to enter, and if not, it determines that the person who enters is a non-operator and makes an alarm to solve the problem of non-operators trailing into the dangerous area, thus causing equipment damage and life safety.

### BRIEF DESCRIPTION OF THE DRAWINGS

FIG. 1 is a first structural schematic diagram of an intelligent security entrance and exit management system according to an embodiment of the present invention is shown;

FIG. 2 is another structural schematic diagram of an intelligent security entrance/exit management system, according to embodiments of the present invention;

FIG. 3 is a schematic diagram of another structure of an intelligent security entrance/exit management system, according to embodiments of the present invention;

FIG. 4 is another structural schematic diagram of an intelligent security entrance/exit management system according to embodiments of the present invention is shown;

FIG. 5 is another structural schematic diagram of an intelligent security entrance/exit management system, according to embodiments of the present invention;

FIG. 6 is another flow diagram of an intelligent security entrance/exit management method according to embodiments of the present invention is shown;

FIG. 7 is a flowchart of a method for triggering a door opening authorization period and performing an operation, in accordance with embodiments of the present invention, is shown;

FIG. 8 is a flowchart of a method for triggering a locking door authorization period and performing operations, according to embodiments of the present invention is illustrated;

FIG. 9 is a flowchart of a method for performing lock door identification, according to embodiments of the present invention;

FIG. 10 is a flowchart of a method for real-time tailgate detection during lockout authorization, according to embodiments of the present invention, is shown;

FIG. 11 is a forward leaning side view of a set of lock bodies and locks, according to embodiments of the present invention, is shown;

FIG. 12 is a rear-tilted side view of a set of lock bodies and locks, according to embodiments of the present invention;

FIG. 13 is a schematic view of a control panel, according to embodiments of the present invention, is shown.

### DETAILED DESCRIPTION

In order to make the purpose, technical solutions and advantages of the present invention clearer, a clear and complete description of the technical solutions in the embodiments of the present invention will be given below in conjunction with the accompanying drawings in the embodiments of the present invention, and it is clear that the described embodiments are a part of the embodiments of the present invention, and not all of them. Based on the embodiments in the present invention, all other embodiments obtained by a person of ordinary skill in the art without creative labor fall within the scope of protection of the present invention. As used herein, the term “including” and variations thereof denote open inclusion, i.e., “including, but not limited to”. Other definitions, both explicit and implicit, may be included below. The operations of the present application are emergency operations and normal operations, where emergency operations include emergency repair and troubleshooting; normal operations include Capital repair, maintenance, and 5S. The control panel of this application is shown in the attached FIG. 13: including the functions of displaying and triggering control of basic information, operation statistics, equipment pictures, product safety management, alarm records, detection management, event records, etc. The control panel is touch-controlled via, for example, a 2-way optically isolated relay module.

The present invention provides an intelligent security entrance/exit management system and method, applied in the field of area protection, with a tapered ned having a removable lock cylinder and/or a guide post and a lock body having a keyhole, wherein the diameter of the keyhole is greater than or equal to the diameter of the lock cylinder, wherein it can be a lock body corresponding to a plurality of tapered neds, and the keyhole is set according to the number of lock cylinders on the tapered ned. Among them, the tapered ned is installed on the door of the protection area, the lock body is installed on the fixed guardrail of the protection area, and the installation position of the lock body and the tapered ned needs to meet the movement range of the lock cylinder can enter the keyhole and the keyhole can lock the lock cylinder. The intelligent security import and export management system and method of the present invention includes a networked status and a disconnected state.

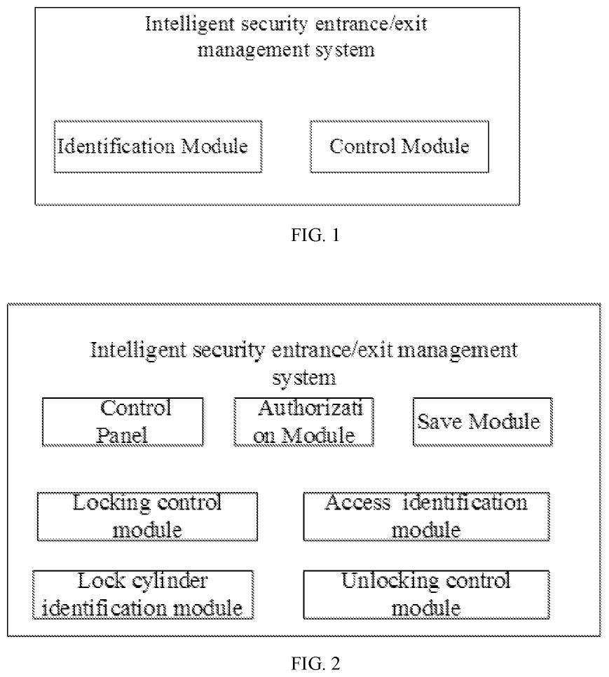

Embodiment 1 of the present invention provides a specific implementation of the intelligent security import and export management system, see FIG. 1, which specifically includes the following: identification module, control module; an identification module for identifying the rights status of the person triggering the unlocking and the movement status of the lock cylinder moving out from the keyhole of the lock body and/or the rights status of the person triggering the locking and the movement status of the lock cylinder moving in towards the keyhole of the lock body, the control module is used to control the triggering of the door opening authorization period and to perform the operation according to the recognition result of the recognition module, causing the lock body to change from the locked status to the unlocked status and then to the locked status and to maintain the locked state, or to control the triggering of the lock door authorization period, causing the lock body to change from the locked status to the unlocked status then to a locked status and maintain the locked state.

Among them, the control module includes the security door lock coil, motor.

Another specific implementation, see FIG. 2, the intelligent security entrance/exit management system further includes a control panel, an authorization module, a Save Module; an identification module includes a Access identification module and a lock cylinder identification module; a control module includes a locking control module and an unlocking control module; control panel is for receiving signals and sending them to the authority identification module, a Save Module for pre-storing information about staff and/or storing information about triggered unlocking personnel with the right to open the door and/or storing information about triggered locking personnel with the right to lock the door, the authority identification module is used to open the door identification and/or lock the door identification of the trigger unlocking personnel according to the signals received from the control panel and the information stored in the Save Module, and when the result of opening the door identification v and/or locking the door identification is passed, then send the opening authorization signal and/or locking authorization signal to the authority module; the signals sent by the control panel include image recognition The control panel sends signals including image recognition, fingerprint recognition and other biological signals, lock cylinder identification module is used to identify the movement status of the lock cylinder in the keyhole, when the identification result is the movement status of the lock cylinder moving out from the keyhole, then send the locking control signal to the locking control module; when the identification result is the movement status of the lock cylinder moving into the keyhole, then send the locking control signal to the locking control module; the authorization module is used to carry out door opening authorization to the trigger unlocking person who has passed the door opening identification, storing the information of the trigger unlocking person who has the right to open the door this time and/or carrying out locking authorization to the trigger unlocking person who has passed the locking door identification, storing the information of the trigger unlocking person who has the right to lock the door this time; and a locking control module for controlling the lock body from the unlocked status to the locked status and maintaining the locked status according to the received locking control signal sent by the lock cylinder identification module, the Unlocking control module is used to control the lock body from the locked status to the unlocked status according to the unlock control signal received from the authorization module, and then send a lock cylinder identification start signal to the lock cylinder identification module for starting the lock cylinder identification module for identification.

In another specific implementation, see FIG. 3, the intelligent security entrance/exit management system further comprises a trigger unlocking person matching module, a trigger locking person matching module; trigger unlocking personnel to open the door identity recognition includes matching the information of the trigger unlocking personnel with the information of the staff with pre-stored authority through the trigger unlocking personnel matching module, and when the matching result for the trigger unlocking personnel is a successful match, the door opening identity recognition is passed; Trigger locking personnel for lock door identification includes matching the information of the trigger locking personnel with the information of the trigger unlocking personnel having the right to open the door this time through the trigger locking personnel matching module, and when the matching result for the trigger locking personnel is a successful match, the lock door identification is passed.

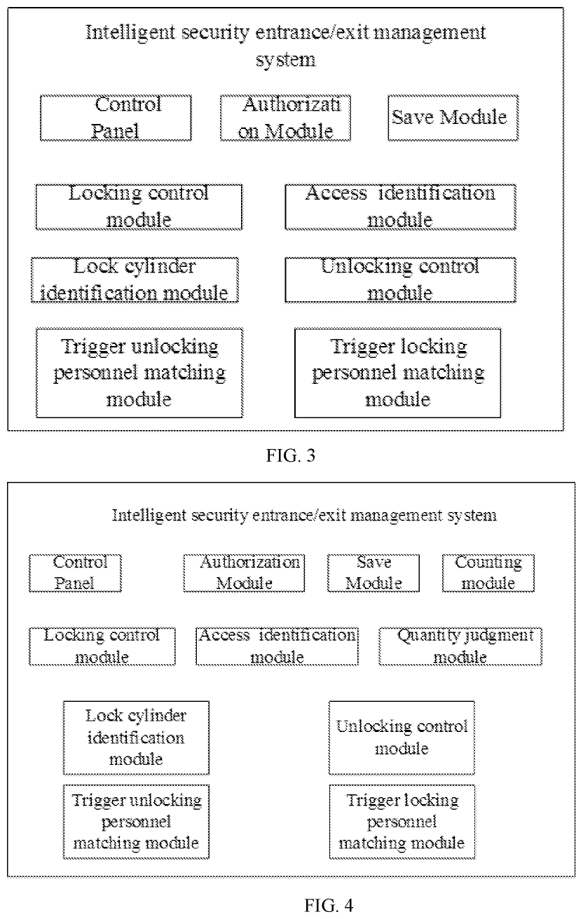

Another specific implementation, see FIG. 4, the intelligent security entrance/exit management system further includes a trigger unlock person matching module, a trigger locking person matching module, a counting module and a quantity judgment module, where the trigger unlocking person is greater than 1 person and the trigger locking person is greater than 1 person, conducting door opening identification includes matching the information of the trigger unlocking personnel greater than 1 person with the information of the staff with pre-stored authority respectively through the trigger unlocking personnel matching module, and when the matching result is all successful, the locking door identification is passed; and the counting module is used to count the triggered locking personnel, specifically including counting the triggered locking personnel, matching the information of the triggered locking personnel greater than 1 person with the stored information of the triggered unlocking personnel with the right to open the door through the triggered locking personnel matching module, and when the matching result is successful for any triggered locking personnel, the counting module will count; and the quantity judgment module is used to judge the counting data of the counting module, and when the counting data of the counting module is the same as the quantity data of the person who triggers unlocking this time, the lock door identity identification is passed.

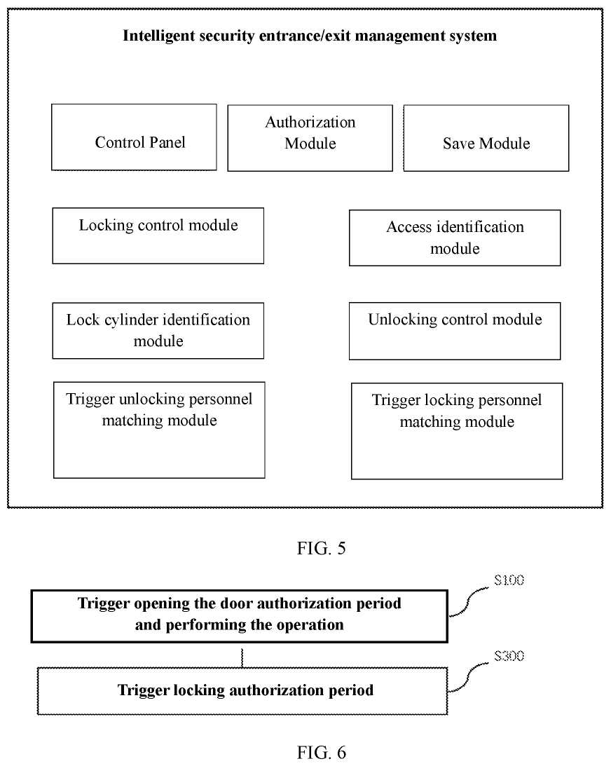

another specific implementation, see FIG. 5, the intelligent security entrance and exit management system also includes a video acquisition module, a motion direction identification module and a judgment module of this trigger unlocking person; video acquisition module for real-time acquisition including video in front of the guarded area door, at the guarded area entrance, and within the guarded area; the motion direction identification module is used to track the person appearing in the video and carry out the identification of motion direction; when the identification result is that the motion direction is from the front of the protective area door to the protective area door to the protective area, the identification of whether the person is this trigger unlocked is carried out; this trigger unlocking person judgment module is used to identify whether it is this trigger unlocking person; when the identification result is not this trigger unlocking person, the tailing alarm is issued.

Embodiment II of the present invention provides a specific implementation of the intelligent security entrance/exit management method applying any of the above intelligent security entrance/exit management systems, see FIG. 6, the method of intelligent security entrance/exit management specifically comprising the steps of: S100: triggering the door opening authorization period and carrying out the operation; the door opening authorization period is the process in which the lock body shifts from the locked status to the unlocked status and then to the locked status and maintains the locked status according to the right status of the person triggering the unlocking and the movement status of the lock cylinder moving out from the keyhole of the lock body; S300: Trigger locking door authorization period; locking door authorization period for the lock body according to the right status of the person who triggered the locking and the movement status of the lock cylinder moving into the keyhole of the lock body, from the locked status to the unlocked status and then to the locked state, and maintain the locked status process.

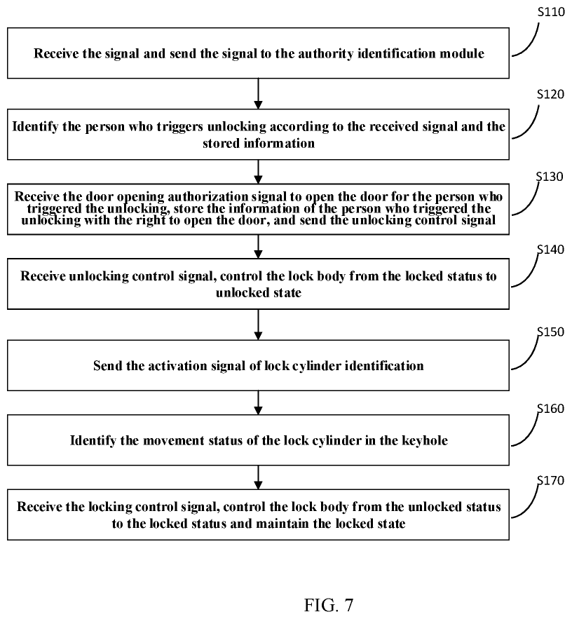

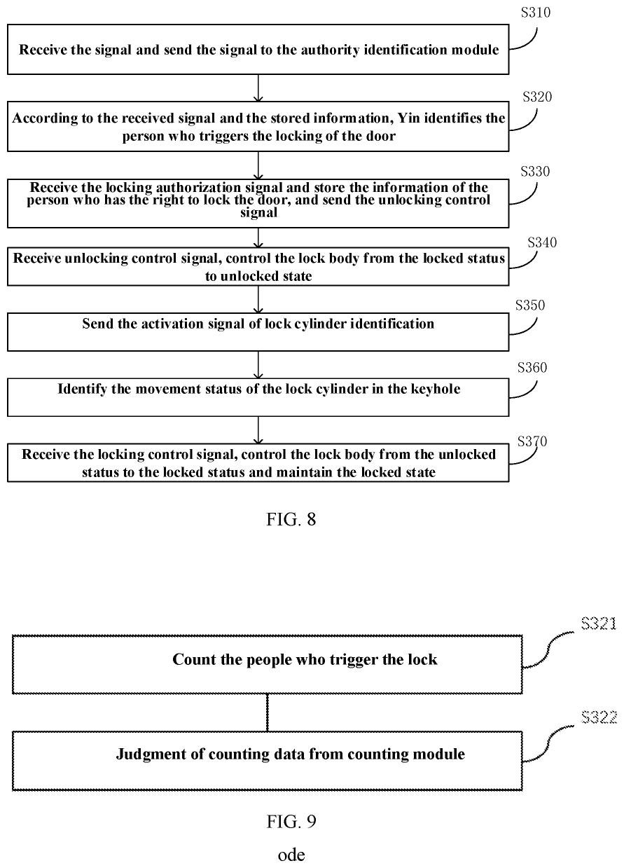

For another specific implementation, see FIG. 7 and FIG. 8, the smart security entrance/exit management method in which step S100 triggers the door opening authorization period and performs the operation specifically includes the steps of: S110: receives the signal and sends the signal to the authority identification module; S120:performs door opening identification of the person triggering unlocking according to the received signal and the stored information, and sends the door opening authorization signal when the door opening identification result is passed; S130: carries out door opening authorization for the trigger unlock person according to the received door opening authorization signal, stores the information of the trigger unlock person with the right to open the door this time, and sends the unlock control signal; and S140: controlling the lock body from the locked status to the unlocked state, according to the received unlocking control signal, S150: sending a lock cylinder identification start signal for activating the lock cylinder identification module for identification; S160: recognizes the movement status of the lock cylinder in the keyhole, and sends a locking control signal when the result of the recognition is the movement status of the lock cylinder moving out from the keyhole; and S170: controlling the lock body from the unlocked status to the locked status and maintaining the locked status according to the received locking control signal.

Wherein, step S300 triggers the lock door authorization during specifically comprising the steps of: S310: receiving the signal and sending the signal to the authority identification module; S320: performing lock door identification of the person triggering the lock according to the received signal and the stored information, and sending a lock door authorization signal when the lock door identification result is passed; S330: performs a lock door authorization on the trigger-on person based on the received lock door authorization signal, stores the information of the trigger-on person with the lock door right this time, and sends an unlocking control signal; and S340: controlling the lock body from the locked status to the unlocked state, according to the received unlocking control signal, S350: sending a lock cylinder identification start signal for activating the lock cylinder identification module for identification; S360: recognizes the movement status of the lock cylinder in the keyhole, and sends a locking control signal when the result of the recognition is the movement status of the lock cylinder moving into the keyhole; and S370: controlling the lock body from the unlocked status to the locked status and maintaining the locked status according to the received locking control signal.

Wherein the intelligent security entrance/exit management method in which triggering the unlocking personnel to perform the door opening identification comprises matching the information of the triggering unlocking personnel with the information of the pre-stored staff having the authority, and when the matching result for the triggering unlocking personnel is a successful match, the door opening identification passes; trigger locking personnel for lock door identification includes matching the information of the trigger locking personnel with the information of the trigger unlocking personnel having the right to open the door this time, and when the matching result for the trigger locking personnel is a successful match, the lock door identification is passed.

Another specific implementation, see FIG. 9, the intelligent security entrance and exit management method, the trigger unlocking personnel is greater than 1 person and the trigger locking personnel is greater than 1 person, the door opening identification includes matching the information of the trigger unlocking personnel greater than 1 person with the information of the staff with pre-stored authority respectively, when the matching result is When all matches are successful, the lock door identification is passed; wherein step S320 in performing lock door identification comprises the steps of: S321: counting the triggered locking persons, matching the information of the triggered locking persons greater than one person with the stored information of the triggered unlocking persons having the right to open the door this time, respectively, and counting the counting module when the matching result for any of the triggered locking persons is a successful match; S322: The counting data of the counting module is judged, and when the counting data of the counting module is the same as the data of the number of people triggered to unlock the door, the lock identification is passed.

For another specific implementation, see FIG. 10, the smart security entrance/exit management method further includes real-time tailing detection after triggering the door opening authorization period; specifically comprising the steps of: S210: real-time acquisition of video including in front of the door of the protected area, at the entrance of the protected area, and within the protected area; S220: tracking the person appearing in the video and identifying the direction of movement; when the identification result is that the direction of movement is from in front of the door of the protection area to the door of the protection area to inside the protection area, the identification of whether it is the person who triggers the unlocking this time is carried out; S230: identify whether it is this trigger to unlock the person; when the identification result is not this trigger to unlock the person, the tailing alarm is issued.

In one embodiment, the lock body in the present invention includes a face recognition screen and/or an unlock/locking indicator and/or a status indicator and/or a reset button and/or a safety emergency stop button and/or a forced unlock keyhole and/or a cooling fan and/or a connector and/or a lock body mounting hole; the tapered ned includes a guide post and/or a slidable tapered ned and/or a door handle mounting waist hole. The locking control module sends a locking control signal and controls the locking indicator light to indicate that the user's current status of the security entry/exit management system is locked; the unlocking control module sends an unlocking control signal and controls the unlocking indicator light to indicate that the user's current status of the security entry/exit management system is unlocked; during the triggering of the door opening authorization, the status indicator light is illuminated to indicate that the user's current status of the security entry/exit management system is unlocked. prompt the user the current status of the security import and export management system for the open authorization period; lock door authorization period, when the lock cylinder identification module to identify the results of the movement of the lock cylinder to the keyhole into the state, press the reset button, the equipment in the hazardous area before starting to improve security; safety emergency stop button, in case of emergency can control the source of danger emergency stop button, in order to block the occurrence of danger or to avoid the occurrence of The danger reaches a more serious situation

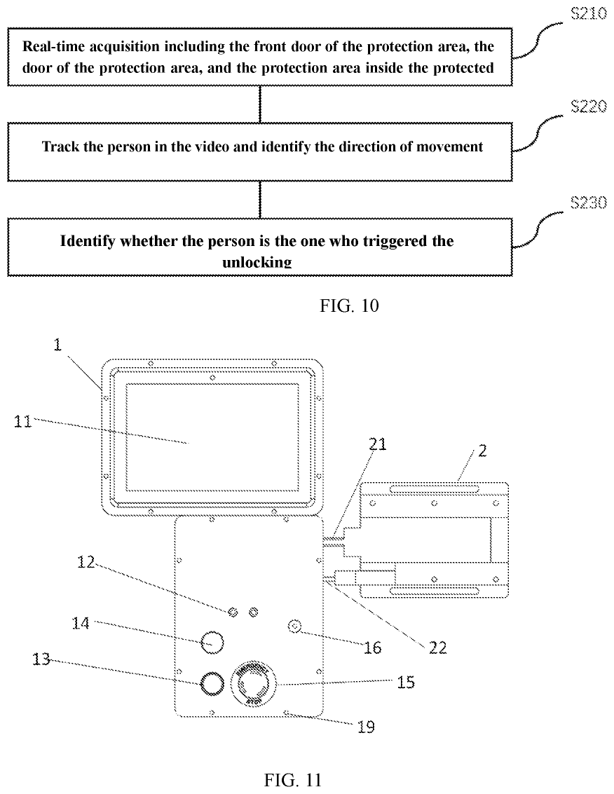

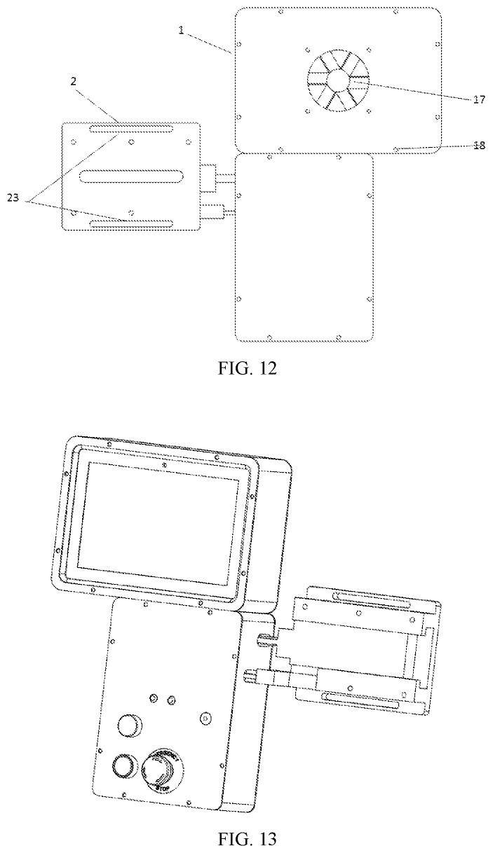

Exemplary, see FIGS. 11 and 12, a lock body 1 and lock 2 for implementing an intelligent security entrance/exit management system and method, wherein the lock body 1 includes a face recognition screen 11, unlock/lock indicator 12, status indicator 13, reset button 14, safety emergency stop button 15, forced unlock keyhole 16, cooling fan 17, lock body mounting hole 18 (location determined by mounting plate or maintenance door), connector 19 for Embodiment, 16 core quick plug connector; wherein, the lock 2 includes guide post 21, slidable lock 22, door handle mounting waist hole 23 (length according to the mounting plate or maintenance door decision), for the function of authorized access to the protected area. It also includes emergency precautions/failure handling measures. In this embodiment, the locking control module sends a locking control signal while controlling the locking indicator light to indicate to the user that the current status of the security entrance/exit management system is locked; the unlocking control module sends an unlocking control signal while controlling the unlocking indicator light to indicate to the user that the current status of the security entrance/exit management system is Unlocked state. During the door opening authorization period, the status indicator lights up to indicate to the user that the current status of the security entrance/exit management system is the door opening authorization period. During the lock door authorization period, when the lock cylinder identification module identifies the result as the movement status of the lock cylinder moving into the keyhole, press the reset button, the equipment in the danger area can only be started to improve safety. Safety emergency stop button, in the event of an emergency can control the source of danger emergency stop button, in order to block the occurrence of danger or to avoid the occurrence of danger has reached a more serious situation.

The application of intelligent safety import and export management system can also be added to the safety controller, is a configurable safety control module, applied to the safety controller, support a variety of safety product components input, the maximum support for 10 groups of safety components input, 4 safety relay output, expandable output module.

In summary, through the technical solution proposed by the present invention, can achieve the function of replanning a new path during the execution of the target mission for the path where the error exists so as to correct the positioning error, and redefine the starting position and movement path of the UAV, because the inspection path established by the UAV at the beginning is often more accurate, and at this time the Positioning system did not produce a large error, which improves the accuracy of the path positioning, and can reduce the problem of collision of UAVs due to the error of the path positioning, because the accuracy of the path positioning is improved, thus improving the target acquired by the UAV moving in that path.

Realizes that after the person with the right to trigger unlocking pulls out the lock cylinder of the lock on the area door from the keyhole of the lock body, no other person can lock the door of the area, thus realizing the effect that before the maintenance personnel leave, the external personnel cannot lock the door of the protected area, solving the problem of life safety of the maintenance personnel caused by being locked in the protected area; enables the person with the right to open the door to have the right to lock the dangerous area The person with the authority to open the door has the authority to lock the dangerous area, so as to solve the problem that the person cannot lock the area and cause the person to enter by mistake, thus causing the safety of life; it can realize the locking of the area only when all the operators are identified to have left the area when more than one person needs to work; it can realize the tracking of the person who enters the protected area from outside the protected area, combined with the judgment of whether the person has the authority to enter If the person does not have the right to enter, the person will be identified as a non-operator and alarmed, so as to solve the problem of non-operators trailing into the dangerous area, thus causing damage to equipment and life safety.

The above description is only a description of the better embodiment of the technical solution of the present invention, not any limitation of the scope of the technical solution of the present invention, and any changes and modifications made by a person of ordinary skill in the field of the technical solution of the present invention according to the above revealed content belong to the scope of protection of the claims.

1. An intelligent security entrance and exit management system, applied in the field of area protection, comprising a tapered ned with a removable lock cylinder and/or guide column and a lock body with a keyhole, the keyhole having a diameter greater than or equal to the diameter of the lock cylinder, wherein the intelligent automatic unlocking and locking device comprises an identification module, a control module;
the identification module identifying the status of entitlement of the person triggering the unlocking and the status of movement of the lock cylinder moving out of the keyhole of the lock body and/or the status of entitlement of the person triggering the locking and the status of movement of the lock cylinder moving in towards the keyhole of the lock body;
the control module controlling the process of triggering the opening of the door during the authorization and carrying out the operation according to the recognition result of the recognition module, causing the lock body to change from the locked status to the unlocked status then to the locked status and to maintain the locked state; or
controlling the process of triggering a locking door authorization during which the lock body is caused to change from a locked status to an unlocked status to a locked status and then to a locked status and to maintain the locked state.

2. An intelligent security entrance/exit management system according to claim 1, further comprising a control panel, an authorization module, and a Save Module; the identification module includes an access identification module and a lock cylinder identification module; the control module includes a locking control module and an unlocking control module;
the control panel for receiving signals and sending the signals to the authority identification module, the Save Module for pre-storing information of staff and/or storing information of the triggered unlocking personnel having the right to open the door and/or storing information of the triggered locking personnel having the right to lock the door;
the authority identification module opening door identification of the trigger unlocking personnel and/or locking door identification of the trigger locking personnel based on the signals received from the control panel and the information stored in the Save Module, and sending an opening authorization signal and/or locking door authorization signal to the authority module when the result of the opening identification and/or the locking door identification is passed;
the lock cylinder identification module identifying the movement status of the lock cylinder in the keyhole, sending a locking control signal to the locking control module when the identification result is the movement status of the lock cylinder moving out from the keyhole; sending a locking control signal to the locking control module when the identification result is the movement status of the lock cylinder moving in towards the keyhole;
the authorization module authorizing the trigger unlocking person who passes the opening identity identification to open the door, storing information of the trigger unlocking person who has the right to open the door this time and/or for authorizing the locking person who passes the locking identity identification to lock the door, storing information of the trigger unlocking person who has the right to lock the door this time;
the locking control module controlling the lock body from an unlocked status to a locked status and maintaining the locked status on the basis of the locking control signal received from the locking core identification module;
the unlocking control module controlling the lock body from the locked status to the unlocked status according to the unlocking control signal received from the authorization module, and then sending a lock cylinder identification start signal to the lock cylinder identification module for starting the lock cylinder identification module for identification.

3. An intelligent security entrance and exit management system, according to claim 2 further comprising a trigger unlocking personnel matching module, a trigger locking personnel matching module;
wherein the triggering unlocking personnel for door opening identification comprises matching information of the triggering unlocking personnel with information of staff with pre-stored authority through the triggering unlocking personnel matching module, when the matching result for the triggering unlocking personnel is a successful match, then the door opening identification passes;
wherein the trigger-on personnel for lock door identification comprises matching the information of the trigger-on personnel with the information of the trigger-unlocked personnel having the right to open the door this time through the trigger-on personnel matching module, and when the matching result for the trigger-on personnel is a successful match, then the lock door identification passes.

4. An intelligent security import and export management system, according to claim 2 further comprising a trigger unlock person matching module, a trigger locking person matching module, a counting module and a quantity judgment module, the trigger unlocking person being greater than 1 person and the trigger locking person being greater than 1 person;
wherein the carrying out door opening identification includes matching the information of the trigger unlocking personnel of the greater than 1 person with the information of the pre-stored staff with authority respectively by the trigger unlocking personnel matching module, when the matching result is all successful, then the locking door identification passes;
wherein the counting module counts the triggered locking personnel, matches the information of the triggered locking personnel of greater than 1 person with the stored information of the triggered unlocking personnel having the right to open the door at this time, respectively, by the triggered locking personnel matching module, and when the matching result for any of the triggered locking personnel is a successful match, then the counting module counts;
wherein the quantity judgment module is used to judge the counting data of the counting module, and when the counting module counting data is the same as the number data of the triggered unlocked person for this time, then the locking door identification passes.

5. An intelligent security import and export management system according to claim 1, further comprising a video acquisition module, a motion direction identification module and a judgment module for this trigger unlocking personnel;
wherein the video acquisition module for real-time acquisition includes video in front of the guarded area door, at the guarded area entrance, and within the guarded area;
wherein the motion direction identification module is used to track the person appearing in the video and carry out the identification of motion direction; when the identification result is that the motion direction is from the front of the protective area door to the entrance of the protective area to the inside of the protective area, the identification of whether the person is this trigger to unlock is carried out;
wherein the trigger unlocking person judgment module is used to identify whether it is this trigger unlocking person; when the identification result is not this trigger unlocking person, the trailing alarm is issued.

6. A smart security entrance/exit management method applying an intelligent security entrance/exit management system as claimed in claim 1, applied in the field of area protection, having a tapered ned with a removable lock cylinder and/or a guide post and a lock body having a keyhole, the keyhole having a diameter greater than or equal to the diameter of the lock cylinder, comprising the steps of:
triggering an open door authorization period and performing the operation; said open door authorization period being the process by which the lock body changes from a locked status to an unlocked status to a locked status and back again, and remains locked, depending on the status of the right of the person triggering the unlocking and the movement of the lock cylinder moving out of the keyhole of said lock body;
triggering the locking door authorization period; said locking door authorization period being the process by which the lock body shifts from a locked status to an unlocked status to a locked status and then to a locked status and maintains the locked status in accordance with the right status of the person triggering the locking and the movement status of the lock cylinder moving in toward the keyhole of said lock body.

7. The intelligent security entrance/exit management method according to claim 6, wherein the triggers to open the door during authorization and conducts the operation specifically comprising the steps of
receiving a signal and sending the signal to the authority identification module;
carrying out door opening identification of the trigger unlocked person according to the received signal and stored information, sending a door opening authorization signal when the door opening identification result is passed;
performing door opening authorization on the trigger unlock person based on the door opening authorization signal received, storing information on the trigger unlock person having the right to open the door this time, and sending an unlocking control signal;
controlling the lock body from a locked status to an unlocked state, according to the unlocking control signal received;
sending a lock cylinder identification start signal for activating the lock cylinder identification module for identification;
identifying the movement status of the lock cylinder in the keyhole, and sending a locking control signal when the result of the identification is the movement status of the lock cylinder moving out from the keyhole;
controlling the lock body to change from an unlocked status to a locked status and to maintain the locked status according to the locked control signal received;
the triggering lock during door authorization specifically comprising the steps of:
receiving a signal and sending the signal to the authority identification module
performing a lock door identification of the trigger locking person based on the received signal and stored information, and sending a lock door authorization signal when the lock door identification result is passed;
performing locking authorization on the trigger-on person according to the locking authorization signal received, storing information about the trigger-on person with locking rights this time, and sending an unlocking control signal;
controlling the lock body to change from a locked status to an unlocked state, according to the unlocking control signal received;
sending a lock cylinder identification start signal for activating the lock cylinder identification module for identification;
identifying the movement status of the lock cylinder in the keyhole, sending a locking control signal when the result of the identification is the movement status of the lock cylinder moving in towards the keyhole;
controlling the lock body from an unlocked status to a locked status and maintaining the locked status according to the locked control signal received.

8. The intelligent security entrance/exit management method according to claim 7, wherein the triggering unlocking personnel for door opening identification comprises matching information of the triggering unlocking personnel with information of pre-stored staff having authority, and when the matching result for the triggering unlocking personnel is a successful match, then the door opening identification passes;
the triggering of locking personnel for lock door identification comprises matching the information of the triggering of locking personnel with the information of the triggering of unlocking personnel having the right to open the door this time the triggering of locking personnel, and when the matching result for the triggering of locking personnel is a successful match, then the lock door identification passes.

9. The intelligent security entrance and exit management method according to claim 7, wherein the trigger unlocking personnel is greater than 1 person and the trigger locking personnel is greater than 1 person, the carrying out door opening identification includes matching the information of the trigger unlocking personnel of the greater than 1 person with the information of the pre-stored staff with authority respectively, when the matching result is all successful, then the lock door identification passes;
the carrying out locking door identification comprises the steps of:
counting the triggered locking personnel, matching the information of the triggered locking personnel greater than one with the stored information of the triggered unlocking personnel having the right to open the door this time respectively, and when the matching result for any of the triggered locking personnel is a successful match, then the counting module counts;
judging the counting data of the counting module, when the counting data of the counting module is the same as the data of the number of the triggered unlocked persons for this time, then the locking door identification passes.

10. The intelligent security entrance and exit management method according to claim 6, wherein the trigger door opening authorization period after also includes real-time tailing detection; specifically includes the following steps:
capturing in real time video including in front of the guarded area door, at the guarded area entrance, and within the guarded area;
tracking the person appearing in the video and performing identification of the direction of movement; when the identification result is that the direction of movement is from in front of the protective area door to the protective area doorway to within the protective area, performing identification of whether or not the person is this trigger to unlock;
identifying whether the person is this trigger to unlock; when the identification result is not this trigger to unlock the person, then issuing a tailing alarm.

11. The intelligent security entrance/exit management method according to claim 6, wherein the lock body includes a face recognition screen and/or an unlock/lock indicator and/or a status indicator and/or a reset button and/or a security emergency stop button and/or a forced unlock keyhole and/or a cooling fan and/or a connector and/or a lock body mounting hole; the tapered ned includes a guide post and/or a slidable tapered ned and/or door handle mounting waist hole.

12. The intelligent security entrance/exit management method according to claim 7, wherein the locking control module sends a locking control signal while controlling the locking indicator light to indicate to the user that the current status of the security entrance/exit management system is locked; the unlocking control module sends an unlocking control signal while controlling the unlocking indicator light to indicate to the user that the current status of the security entrance/exit management system is unlocked. During the triggering door opening authorization, the status indicator lights up to indicate the user's current status of the security import and export management system for the door opening authorization period; during the locking authorization period, when the lock cylinder identification module identifies the result as the movement status of the lock cylinder moving into the keyhole, press the reset button, the equipment in the hazardous area can be started to improve safety; the safety emergency stop button, in the event of an emergency can control the source of danger emergency stop button, in order to block the occurrence of danger or to avoid the occurrence of danger has reached a more serious situation.
